(19) United States
(12) Patent Application Publication
(10) Pub. No.: US 2003/0074414 A1
(43) Pub. Date: Apr. 17, 2003

(54) Electronic mail rejecting system, method therefor, and storage medium storing control program thereof

(75) Inventor: Atsushi Shibuya, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/270,671

(22) Filed: Oct. 16, 2002

(30) Foreign Application Priority Data
Oct. 17, 2001 (JP) 318792/2001

(51) Int. Cl. G06F 15/16

(52) U.S. Cl. 709/206; 709/217

(57) ABSTRACT

An electronic mail rejecting system can reject specific electronic mails with relatively simple operation on a mobile terminal. The system includes an electronic mail relaying component relaying an electronic mail from a sender terminal to a receiver terminal, a specific electronic mail returning component returning for notifying that the received electronic mail is a specific electronic mail to a specific mail processing component when the received electronic mail is the specific electronic mail, and the specific mail processing component identifying the sender of the specific electronic mail on the basis of a content of a return mail returned from the specific electronic mail returning component and information obtained from the electronic mail relaying component.

### BACKGROUND OF THE INVENTION

1. Field of the Invention

The present invention relates generally to an electronic mail rejecting system, a method therefor and a storage medium storing a control program thereof. More particularly, the invention relates to an electronic mail rejecting system rejecting reception of specific electronic mails in a mobile terminal, such as cellular phone, Personal Handy Phone System (PHS) and so forth, a method therefor and a storage medium storing a control program thereof.

2. Description of the Related Art

In the recent years, mobile terminals having electronic mail receiving function, such as cellular phone, Personal Handy Phone System (PHS) and so forth, are rapidly spreading. Hereinafter, the word “cellular phone” is used to represent all mobile communication terminals including Personal Handy Phone System (PHS) and other handy or portable phone, car phones and so forth. In a mailing function of the cellular phone or the like, a telephone number is frequently used as mail address. Using the telephone number of the mail address is particularly effective for terminals having limited input means, such as the cellular phone to provide superior convenience. However, when the mail address is telephone number, it is naturally convenient for those sending out mails to a large number of unidentified addressees since telephone number is consisted of a fixed digit of numeric characters with finite number of combinations thereof.

Therefore, unwanted particular mails, such as nuisance mails and so forth, are frequently sent to the cellular phone or the like. In mailing system for the cellular phone, data communication fees are frequently charged to recipients. Therefore, the user of the cellular phone is charged for unwanted and unilaterally sent nuisance mails.

Conventionally, measure for such nuisance mail has been taken to change the mail address from combination of numeric characters to combination of arbitrary number of numeric characters and alphabetic characters. Furthermore, another or further measure has been taken to attach particular keyword to the mail address, such as personal identification number or the like for avoiding the nuisance mails.

However, when the mail address is changed or when the personal identification number is added, new mail address and/or personal identification number have to be notified to counterparts exchanging electronic mails in advance. Accordingly, once the mail address is changed or the personal identification number is added, mails from those not known the new mail address and/or the personal identification number cannot be received to cause inconvenience.

On the other hand, as a method for avoiding reception of the nuisance mail, there is a method for setting rejection of mails from particular mail addresses in a mail server. In this method, it encounters a shortcoming in that every mail addresses of nuisance mails have to be set for rejection from time to time. Furthermore, sender of such nuisance mail may dishonestly alter the mail address to be attached to the nuisance mail. Therefore, it is not practically possible to completely avoid the nuisance mails.

Furthermore, in case of the mobile terminal, such as cellular phone, detailed header identifying the sender side mail server due to limitation in memory and communication data amount. In such case, rejection of nuisance mail becomes not possible.

### SUMMARY OF THE INVENTION

Therefore, it is an object of the present invention to provide an electronic mail rejecting system, a method therefor and a storage medium storing a control program thereof, which can reject specific electronic mails with relatively simple operation on a mobile terminal.

According to the first aspect of the present invention, an electronic mail rejecting system rejecting reception of an electronic mail transmitted and received between terminals through a communication network, comprises:

electronic mail relaying means for relaying an electronic mail from a sender terminal to a receiver terminal;

specific electronic mail returning means provided in the receiver terminal, for returning for notifying that the received electronic mail is a specific electronic mail to a specific mail processing means when the received electronic mail is the specific electronic mail; and

the specific mail processing means provided between the receiver terminal and the sender terminal, for identifying the sender of the specific electronic mail on the basis of a content of a return mail returned from the specific electronic mail returning means and information obtained from the electronic mail relaying means.

According to the second aspect of the present invention, an electronic mail rejecting method for rejecting an electronic mail transmitted and received between terminals via a communication network, comprises:

disposing an electronic mail relaying portion between a sender terminal and a receiver terminal for relaying an electronic mail from the sender terminal to the receiver terminal;

specific electronic mail returning step of returning from the receive terminal for notifying that the received electronic mail is a specific electronic mail to a specific mail processing means when the received electronic mail is the specific electronic mail; and

specific mail processing step of identifying the sender of the specific electronic mail on the basis of a content of a return mail returned from the receive terminal and information obtained from the electronic mail relaying portion.

According to the third aspect of the present invention, a storage medium storing a control program for implementing an electronic mail rejecting method for rejecting an electronic mail transmitted and received between terminals via a communication network, and disposed an electronic mail relaying portion between a sender terminal and a receiver terminal for relaying an electronic mail from the sender terminal to the receiver terminal, the control program comprises the steps of:

specific electronic mail returning step of returning from the receiver terminal for notifying that the received electronic mail is a specific electronic mail to a specific mail processing means when the received electronic mail is the specific electronic mail; and

specific mail processing step of identifying the sender of the specific electronic mail on the basis of a content of a return mail returned from the receiver terminal and information obtained from the electronic mail relaying portion.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a schematic block diagram showing an overall construction of the preferred embodiment of an electronic mail rejecting system according to the present invention;

FIG. 2 is an illustration showing one example of a structure of an electronic mail;

FIG. 3 is an illustration showing one example of a mail header;

FIG. 4 is an illustration showing one example of a body of the mail;

FIG. 5 is a flowchart showing one example of a nuisance mail rejection setting process;

FIG. 6 is a flowchart showing one example of a nuisance mail rejection process after the nuisance mail rejection setting process;

FIG. 7 is an illustration showing one example of mail header to be transmitted to a nuisance mail rejection processing server from a mobile terminal; and

FIG. 8 is an illustration of one example of the body of the mail to be sent back to the nuisance mail rejection processing server from the mobile terminal.

### DESCRIPTION OF THE PREFERRED EMBODIMENT

The present invention will be discussed hereinafter in detail in terms of the preferred embodiment of an electronic mail rejecting system, a method therefor and a storage medium storing a control program thereof, in accordance with the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure is not shown in detail in order to avoid unnecessary obscurity of the present invention.

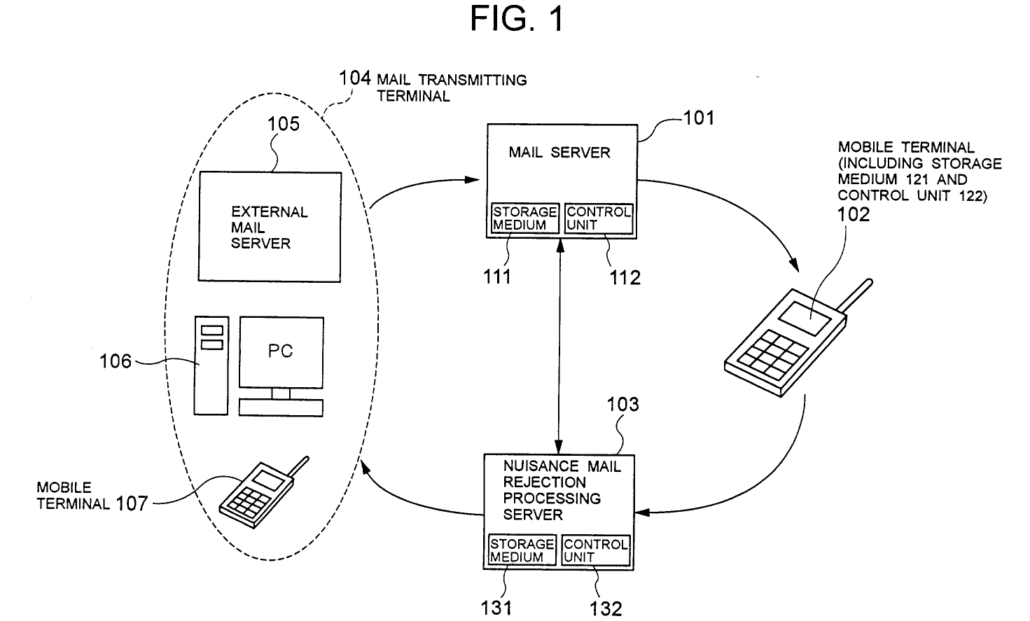

FIG. 1 is a schematic block diagram showing an overall construction of the preferred embodiment of an electronic mail rejecting system according to the present invention. Referring to FIG. 1, the preferred embodiment of a main rejection system is constructed with a mail server 101, a mobile terminal 102, a nuisance mail rejection processing server 103 and a mail transmitting terminal 104. On the other hand, the mail server 101 includes a storage medium 111 storing a control program which will be discussed later and a control unit 112 executing an electronic mail rejecting method according to the control program. Similarly, the mobile terminal 102 includes a storage medium 121 (not shown) storing a control program which will be discussed later, and a control unit 122 (not shown) executing an electronic mail rejecting method according to the control program. Also, the nuisance mail rejection processing server 103 includes a storage medium 131 storing a control program which will be discussed later and a control unit 132 executing an electronic mail rejecting method according to the control program.

The mail server 101 relays an electronic mail from a communication network, such as internet or an electronic mail transmitted and received between mobile terminals. Namely, the mail server 101 has a function to receive the electronic mail from the internet or the mobile terminal for temporary storage and transmit the electronic mail to the mobile terminal designated as recipient. Also, the mail server 101 has a function for storing log including date of transmission and reception of the electronic mail, sender, recipient and so forth.

The mobile terminal 102 has a function for receiving data, such as electronic mail and so forth by radio communication. The mobile terminal 102 may be a cellular phone, PHS and so forth, for example. The mobile terminal 102 receives the electronic mail from the mail server 101 and displays mail information on a display portion, such as a liquid crystal display or the like. A user may read the mail information displayed on the display portion and perform browsing operation, return mailing operation, deleting operation and so forth through an operating portion constituted of operation buttons and so forth.

The nuisance mail rejection processing server 103 has a function for receiving the electronic mail transmitted from the mobile terminal 102 and analyzing data of the electronic mail. In data analysis of the electronic mail, inquiry is made to the mail server for extracting sender of the electronic mail in question from log. The nuisance mail rejection processing server 103 has a database storing the extracted sender. On the other hand, the nuisance mail rejection processing server 103 has a function for transmitting a caution mail to the sender upon receive of the electronic mail identifying the electronic mail in question as nuisance mail from the mobile terminal.

The mail transmitting terminal 104 is a terminal capable of sending the electronic mail to the mobile terminal 102. The mail transmitting terminal 104 is constructed with an external mail server 105, a personal computer (PC) 106, a mobile terminal 107 and so forth.

The external mail server 105 is other mail server connected to the internet. The personal computer 106 has a mail transmitting and receiving function for transmitting and receiving the electronic mail to the external mail server 105. The mobile terminal 107 is the cellular phone, PHS or the like, and has a transmitting and receiving function of the electronic mail. The mobile terminal 107 performs transmission and reception of the electronic mail through the external server 105 or the like.

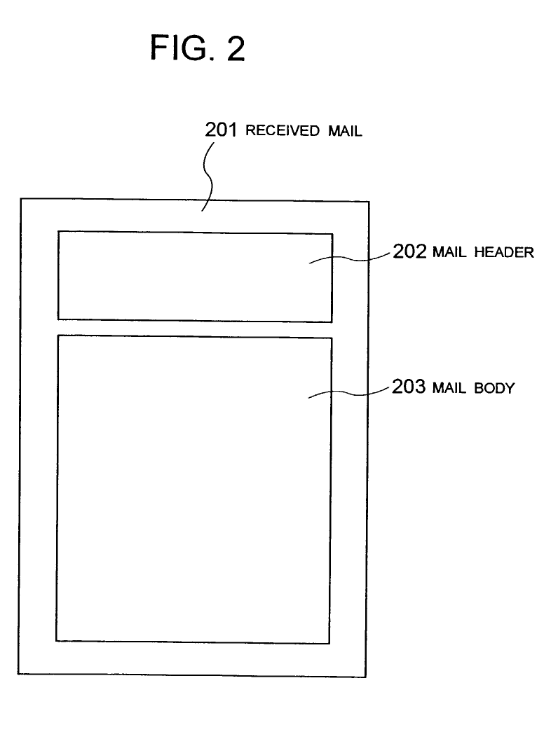

FIG. 2 is an illustration showing one example of the electronic mail. FIG. 2 shows overall structure of the electronic mail, for example received mail. The received mail 201 includes a mail header 202 and a mail body 203.

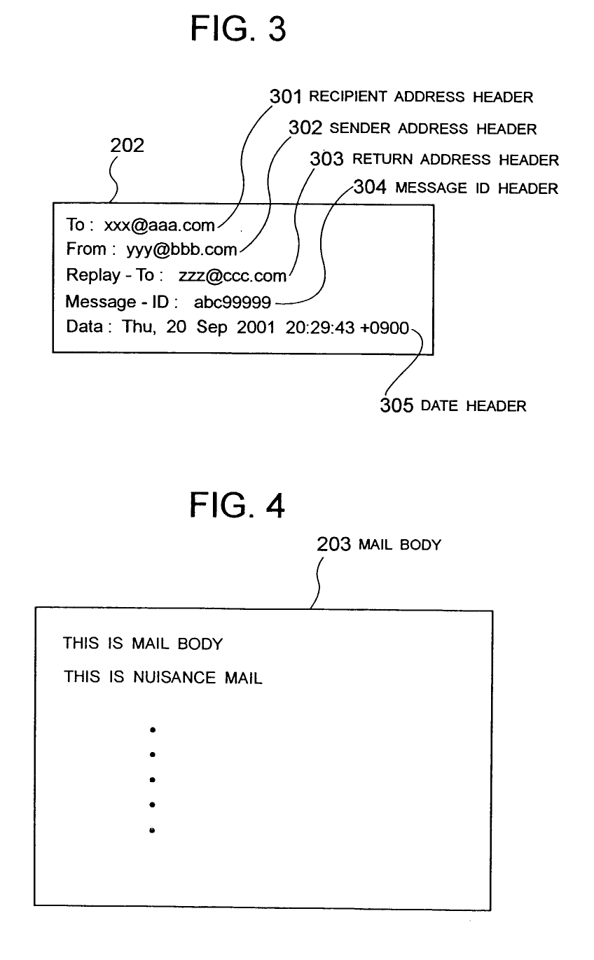

FIG. 3 is an illustration showing a structure of one example of the mail header 202. The mail header 202 is constructed with a recipient address header (e.g. xxx@aaa.com) 301, a sender address header (e.g. yyy@bbb.com) 302, a return address header (e.g. zzz@ccc.com) 303, a message ID header (e.g. abc99999)304, and a date header (e.g. Thu, 30 Sep 201 20:29:43 +0900) 305 and so forth.

FIG. 4 is an illustration showing one example of the mail body 203. Referring to FIG. 4, the mail body 203 contains mail message consisted of character strings.

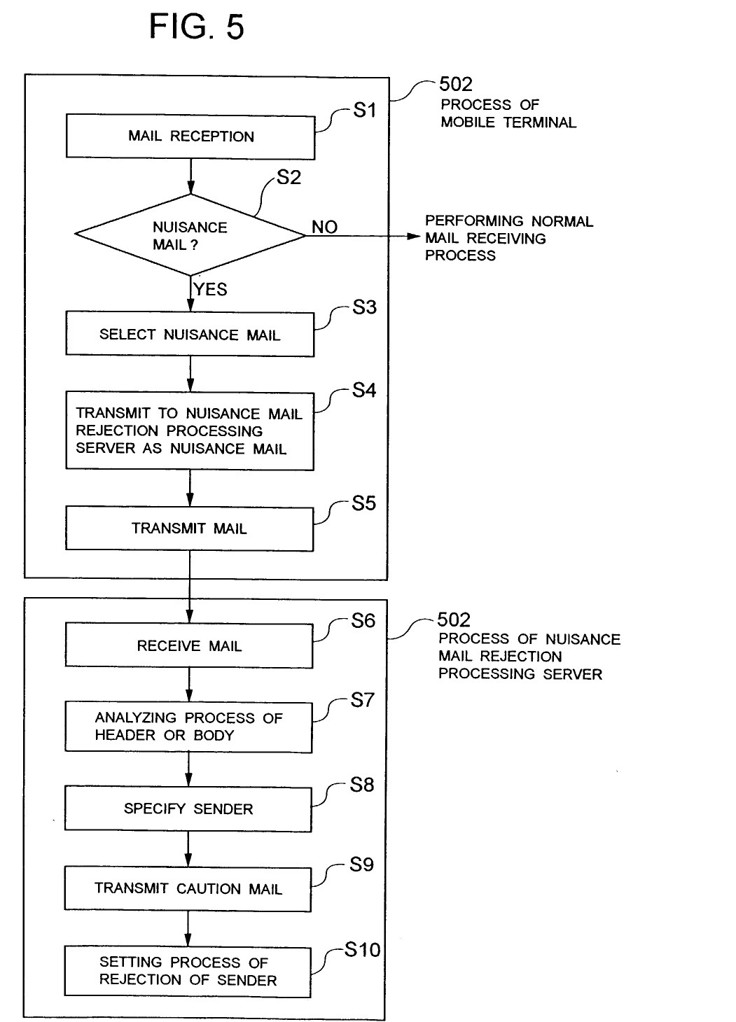

FIG. 5 is a flowchart showing one example of a nuisance mail rejection setting process. Referring to FIG. 5, the nuisance mail rejecting process is consisted of a process 501 of the mobile terminal 102 and a process 502 of the nuisance mail rejection process by the nuisance mail rejection processing server 103. On the other hand, the process 501 shows a procedure in the case where the nuisance mail is received in the mobile terminal 102. The process 502 shows process to be performed for the nuisance mail by the nuisance mail rejection processing server 103 when the mobile terminal 102 returns the nuisance mail to the nuisance mail rejection processing server 103 in the process 501.

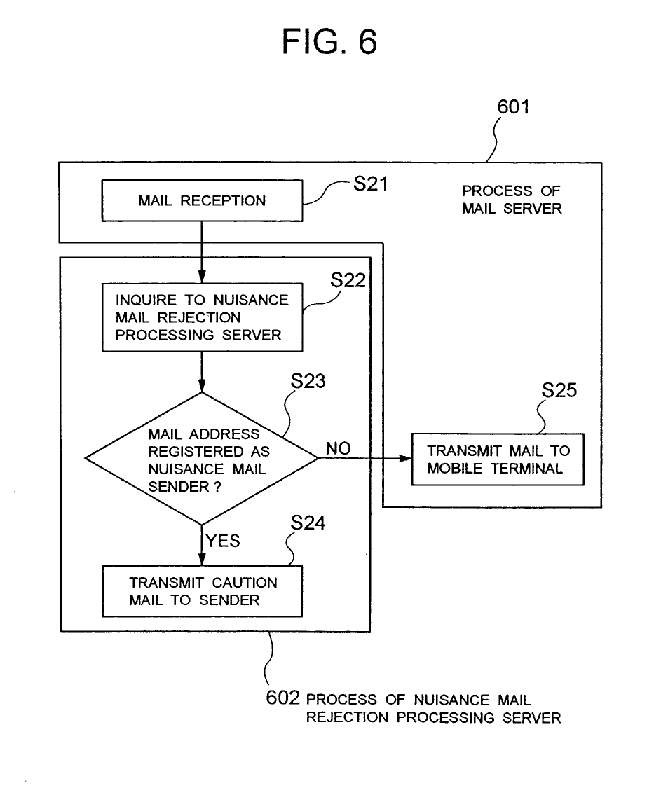

FIG. 6 is a flowchart showing one example of the process for the nuisance mail after the nuisance mail rejection setting. Referring to FIG. 6, the process after the nuisance mail rejection setting is consisted of a process 601 of the mail server 101 and a process 602 of the nuisance mail rejection processing server 103. In the process 601 of the mail server 101, only reception and transmission of the electronic mail is performed. The process 602 in the nuisance mail rejection processing server 103 is consisted of a process to check where the electronic mail in question is with the mail addresses registered as senders of the nuisance mails, and a process to send out a caution mail to the sender of the nuisance mail.

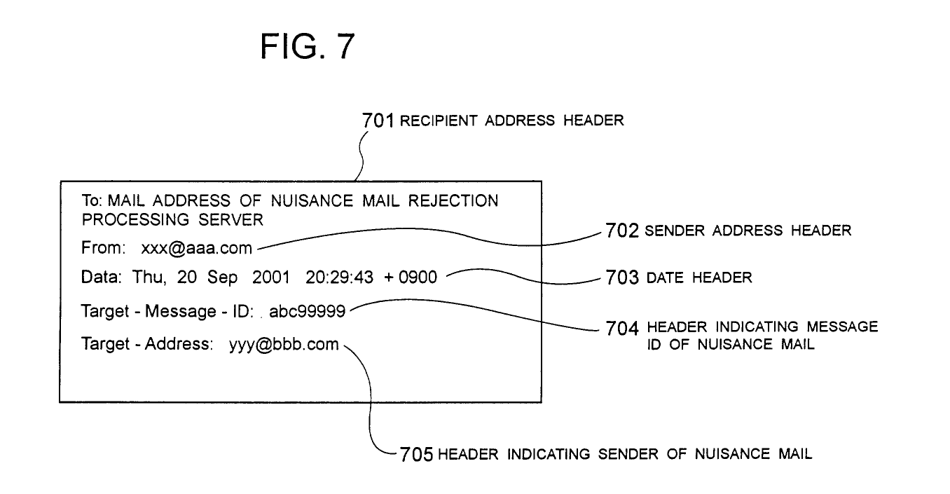

FIG. 7 is an illustration showing one example of the header of the mail to be returned from the mobile terminal 102 to the nuisance mail rejection processing server 103. Referring to FIG. 7, in a recipient header 701, the mail address to return mailing is indicated. As the recipient, the mail address of the nuisance mail rejection process server 103 is designated. In a sender header 702, the mail address of the own terminal (e.g. xxx@aaa.com) is indicated. In a date header 703, date and time upon returning the electronic mail (e.g. Thu, 20 Sep 2001 20:29:43 +0900) is indicated. In a header 704 indicating the message ID (Target-Message-ID) of the nuisance mail, the message ID (e.g. abc99999) upon receipt of the nuisance mail is indicated. In a header 705 identifying the sender (Target-Address) of the nuisance mail, the sender (e.g. yyy@bbb.com) upon receipt of the nuisance mail is indicated. It should be noted that the content of the recipient header 701, namely the mail address of the nuisance mail rejection processing server 103, is preliminarily set.

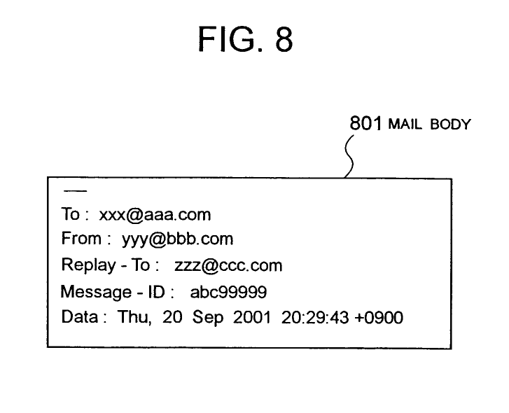

FIG. 8 is an illustration showing one example of a structure of the body of the mail to be returned to the nuisance mail rejection processing server 103 from the mobile terminal 102. Referring to FIG. 8, in the mail body 801, a message to be returned is indicated. In the body, a header information of the electronic mail received as the nuisance mail is copied.

Next, operation of the shown embodiment will be discussed hereinafter. At first, normal electronic mail reception process will be discussed with reference to FIG. 1. From the mail transmitting terminal 104 as the sender of the nuisance mail, the electronic mail is transmitted to the mobile terminal 102. The electronic mail transmitted from the mail transmitting terminal 104 is stored once in the mail server 101, converted into the mail structure adapted to the mobile terminal 102 (see FIGS. 2, 3 and 4) and then transmitted to the mobile terminal 102. Conversion of the mail structure is performed by adding minimum information for the mobile terminal having small data storage capacity. The mobile terminal 102 stores the received mail. The user may browse the received mails to make identification of the sender based on the mail header of FIG. 3.

Subsequently, discussion will be given for receiving process of the electronic mail unique to the present invention with reference to FIG. 5. At first, the mobile terminal 102 receives the electronic mail from the mail transmitting terminal 104 (S1). Next, the user browses the received electronic mail and makes judgment whether the received mail is the nuisance mail on the basis of the mail header 202 of FIG. 3 and the content of the mail body 401 of FIG. 4 (S2). When the user makes judgment that the received electronic mail is the nuisance mail (answer at step S2 is YES), the electronic message identified as nuisance mail is selected (S3) to perform return mailing process of the nuisance mail to the nuisance mail rejection processing server 103 (S4, S5). It should be noted that the return mailing process of the nuisance mail in the mobile terminal 102 is easily performed through operation by button or operation on a menu. On the other hand, if the user makes judgment that the received electronic mail in question is not the nuisance mail at step S2 (answer at step S2 is NO), normal mail receiving process is performed.

Next, discussion will be given for return mailing process of the nuisance mail. In the received electronic mail, the message ID 304 is added and the message ID 704 of the nuisance mail is added to the header of the return mail in the return mailing process of the nuisance mail (see FIG. 7). On the other hand, upon return mailing, the header 202 of the received nuisance mail is copied and pasted in the mail body 801 (see FIG. 8). Then, the return mail is transmitted to the nuisance mail rejection processing server 103 (see S5 of FIG. 5).

On the other hand, in the nuisance mail rejection processing server 103, the electronic mail (return mail) transmitted from the mobile terminal 102 is received (S6 of FIG. 5). Then, the nuisance mail rejection processing server 103 performs analysises of the header and the mail body of the received electronic mail (S7 of FIG. 5).

The mail server 101 records information including time, reception path, sender, message ID of the mail and so forth extracted from the header of the electronic mail, as log, upon transmitting the electronic mail to the mobile terminal 102.

In the analyzing process at step S7, the message ID 704 of the nuisance mail indicated in the header (FIG. 7) of the electronic mail returned from the mobile terminal 102 as the nuisance mail and the header indicating the sender of the nuisance mail 705, is extracted to identify the sender of the nuisance mail.

Next, in the sender identifying process (S8 of FIG. 5), the nuisance mail rejection processing server 103 makes inquiry to the log of the mail server 101. Namely, the sender is identified by comparing the log recorded in the mail server 101 and the message ID written in the header of the electronic mail returned as the nuisance mail.

It should be noted that the sender may be identified by the sender (see the sender header 302 of FIG. 3) preliminarily added to the nuisance mail. However, the sender address is frequently altered dishonestly. Even when the sender address is altered, it can be perceive alternation by comparing the reception path in the log stored in the mail server 101 and the mail address of the sender.

On the other hand, when the message ID and the sender of the nuisance mail cannot be added to the header shown in FIG. 7, the header information of the nuisance mail can be pasted in the mail body 801 of the return mail as shown in FIG. 8.

When the sender is successfully identified (S8) in analyzing process (s7 of FIG. 5), the caution mail is transmitted (S9) to the identified sender of the nuisance mail.

On the other hand, at the same time of sending the caution mail, setting of nuisance mail rejection is performed (S10). The rejection setting process is performed by the nuisance mail rejection processing server 103. It should be noted that, in case of the nuisance mail, it is possible that the sender address header 302 and the return address header 303 is held in blank. In such case, the external mail server 105 to be the sender is identified from the header 704 indicating the message ID of the nuisance mail shown in FIG. 7 or the message ID shown in FIG. 8. Identification of the external mail server 105 performed on the basis of the log stored in the mail server 101. In the log, the message ID is contained. Therefore, by retrieving the long with taking the message ID as keyword, the mail server 105 as sender of the nuisance mail can be identified. Also, the nuisance mail rejection processing server 103 can performing setting of rejection for the terminal 102 by identifying the sender or the external mail server 105 of the sender.

Next, discussion will be given for mail receiving operation after nuisance mail rejection setting with reference to FIG. 6. In the nuisance mail rejection processing server 103, database of setting of the rejection for the mobile terminal 102 is established. When the mail server 101 receives the electronic mail from the mail transmitting terminal 104 (S21), the mail server 101 makes inquiry whether the electronic mail in question is nuisance mail or not to the nuisance mail rejection processing server 103 (S22). The nuisance mail rejection processing server 103 receiving the inquiry compares the sender address of the electronic mail in question with the sender addresses or the server addresses to be the sender set in the database for mail rejection for checking whether the sender address or the address of the server to be the sender is registered as sender of the nuisance mail (S23). Then, if the sender address or server address of the mail in question is already registered as sender of the nuisance mail (YES at step S23). The nuisance mail rejection processing server 103 transmits the caution mail to the sender of the nuisance mail (S24). At the same time, the nuisance mail rejection processing server 103 sends instruction to the mail server 101 not to send the electronic mail in question to the mobile terminal 102.

On the other hand, when the sender address or the server address of the sender is not registered as the nuisance mail in the database for mail rejection in the nuisance mail rejection processing server 103 (NO at step S23), the nuisance mail rejection processing server 103 does not transmit the caution mail to the sender of the electronic mail in question. The nuisance mail rejection processing server 103 notifies to the mail server 101 that the electronic mail in question is not the nuisance mail. Then, the mail server 101 makes judgment that the electronic mail in question is not one of the mail to be set for rejection to transmit the electronic mail to the mobile terminal 102 (S25).

Next, discussion will be given for releasing one sender address from the database for mail rejection in the nuisance mail rejection processing server 103. The nuisance mail rejection processing server 103 establishes the database of the senders of the nuisance mail by return mailing operation of the mobile terminal 102. The database can be browsed by the mobile terminal 102. The setting of the sender for rejection of the nuisance mail can be released from the mobile terminal 102. On the other hand, when the sender of the electronic mail is erroneously set as sender of the nuisance mail from the mobile terminal 102, the user may modify setting in the database.

It should be noted that, in FIG. 1, the mail server 101 and the nuisance mail rejection processing server 103 are established as independent servers for respective usage. However, it is also possible to establish the mail server 101 and the nuisance mail rejection processing server 103 as single server.

Finally, discussion will be given for the control program for rejecting the electronic mail. The control program for implementing the processes (S1 to S5) shown in the flowchart of FIG. 5 is stored in the storage medium 121 (not shown) in the mobile terminal 102. The control unit 122 (not shown) in the mobile terminal 102 reads out the program for executing the processes (S1 to S5) from the storage medium 121 to make judgment whether the received electronic mail is nuisance mail or not. If judgment is made that the received electronic mail is the nuisance mail, the electronic mail is transmitted to the nuisance mail rejection processing server 103 to leave the process of the nuisance mail to the nuisance mail rejection processing server 103. On the other hand, if judgment is made that the received electronic mail is not the nuisance mail, normal electronic mail receiving process is performed.

Similarly, the program for implementing the processes (S6 to S10) shown by the flowchart of FIG. 5 is stored in a storage medium 131 in the nuisance mail rejection processing server 103. A control unit 132 in the nuisance mail rejection processing server 103 reads out the program for executing the processes (S6 to S10) from the storage medium 131 to make analysis of the received electronic mail from the mobile terminal 102 according to the program for identification of the sender, transmission of the caution mail to the sender and setting of the sender for rejecting the mail therefrom.

Furthermore, a program for executing the processes (S22 to S24) shown in the flowchart of FIG. 6 is stored in the storage medium 131 in the nuisance mail rejection processing server 103. The nuisance mail rejection processing server 103 makes judgment whether the electronic mail received by the mail server 101 is sent from the sender registered in the database as senders of the nuisance mail, or not according to the read program. If registered, the caution mail is transmitted to the sender. If nor registered, the nuisance mail rejection processing server 103 notifies to the mail server 101 that the electronic mail in question is not the nuisance mail.

Similarly, a program for executing the processes (S21 to S25) shown in the flowchart of FIG. 6 is stored in the storage medium 111 in the mail server 101. The control unit 112 in the mail server 101 reads out the program for executing the processes (S21 to S25) from the storage medium 111 to transmit the received electronic mail to the nuisance mail rejection processing server 103 to request judgment whether the electronic mail in question is the mail sent from the sender of the nuisance mail, and to transmit the electronic mail to the mobile terminal 102 when the electronic mail in question is not the nuisance mail.

With the present invention, an electronic mail rejecting system rejecting reception of an electronic mail transmitted and received between terminals through a communication network, comprises electronic mail relaying means for relaying an electronic mail from a sender terminal to a receiver terminal;

specific electronic mail returning means provided in the receiver terminal, for returning for notifying that the received electronic mail is a specific electronic mail to a specific mail processing means when the received electronic mail is the specific electronic mail, and the specific mail processing means provided between the receiver terminal and the sender terminal, for identifying the sender of the specific electronic mail on the basis of a content of a return mail returned from the specific electronic mail returning means and information obtained from the electronic mail relaying means for permitting the user to reject reception of the specific electronic mail by relatively simple operation through the mobile terminal.

More particularly, rejection of the mail which the user does not want to receive can be set by simple operation on the terminal. Also, by transmitting the caution mail to the sender of the nuisance mail, transmission of the nuisance mail can be restricted against the sender. Furthermore, the user may browse the setting condition in setting of the rejection of the nuisance mail using the mobile terminal and modify the setting of the rejection of the nuisance mail.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An electronic mail rejecting system rejecting reception of an electronic mail transmitted and received between terminals through a communication network, comprising:
electronic mail relaying means for relaying an electronic mail from a sender terminal to a receiver terminal;
specific electronic mail returning means provided in said receiver terminal, for returning for notifying that the received electronic mail is a specific electronic mail to a specific mail processing means when the received electronic mail is the specific electronic mail; and
specific mail processing means provided between said receiver terminal and said sender terminal, for identifying the sender of said specific electronic mail on the basis of a content of a return mail returned from said specific electronic mail returning means and information obtained from said electronic mail relaying means.

2. An electronic mail rejecting system as set forth in claim 1, wherein said specific electronic mail processing means includes a function for transmitting a caution mail to the identified sender.

3. An electronic mail rejecting system as set forth in claim 1, wherein said specific mail processing means includes a function for performing setting of rejection of electronic mail from said identified sender.

4. An electronic mail rejecting system as set forth in claim 1, wherein said electronic mail relaying means includes a function for inquiring said specific mail processing means whether the electronic mail obtained from said sender terminal corresponds to said specific electronic mail or not.

5. An electronic mail rejecting system as set forth in claim 4, wherein said specific mail processing means includes a function for making judgment whether said electronic mail corresponds to said specific electronic mail or not, in response to the inquiry from said electronic mail relaying means.

6. An electronic mail rejecting system as set forth in claim 5, wherein said specific mail processing means issues instruction for stopping transmission of said electronic mail to said electronic mail relaying means when said electronic mail corresponds to said specific electronic mail.

7. An electronic mail rejecting system as set forth in claim 1, wherein said specific electronic mail processing means has a database of the senders of the specific electronic mails, and said database is accessible from said receiver terminal for browsing and releasing setting for mail rejection.

8. An electronic mail rejecting system as set forth in claim 1, wherein said specific mail returning means adds header information of the received electronic mail to a header of a return mail, or copies and pastes the header information of the received electronic mail to an electronic mail body, for returning to said specific electronic mail processing means.

9. An electronic mail rejecting system as set forth in claim 1, wherein said specific electronic mail processing means identifies the sender of said specific electronic mail on the basis of a message ID of the sender transmitted from said specific electronic mail returning means and a log obtained from said electronic mail relaying means.

10. An electronic mail rejecting method for rejecting an electronic mail transmitted and received between terminals via a communication network, comprising:
disposing an electronic mail relaying portion between a sender terminal and a receiver terminal for relaying an electronic mail from said sender terminal to said receiver terminal;
specific electronic mail returning step of returning from said receiver terminal for notifying that the received electronic mail is a specific electronic mail to a specific mail processing portion when the received electronic mail is the specific electronic mail; and
specific mail processing step of identifying the sender of said specific electronic mail on the basis of a content of a return mail returned from said receiver terminal and information obtained from said electronic mail relaying portion.

11. An electronic mail rejecting method as set forth in claim 10, wherein said specific electronic mail processing step includes a step of transmitting a caution mail to the identified sender.

12. An electronic mail rejecting method as set forth in claim 10, wherein said specific mail processing step includes a step of performing setting of rejection of electronic mail from said identified sender.

13. An electronic mail rejecting method as set forth in claim 10, wherein said electronic mail relaying portion includes a step of inquiring said specific mail processing portion whether the electronic mail obtained from said sender terminal corresponds to said specific electronic mail or not.

14. An electronic mail rejecting method as set forth in claim 13, wherein said specific mail processing step includes step of making judgment whether said electronic mail corresponds to said specific electronic mail or not, in response to said inquiry from said electronic mail relaying portion.

15. An electronic mail rejecting method as set forth in claim 14, wherein instruction for stopping transmission of said electronic mail is issued to said electronic mail relaying portion in said specific mail processing step when said electronic mail corresponds to said specific electronic mail.

16. An electronic mail rejecting method as set forth in claim 10, wherein a database of the senders of the specific electronic mails is established in said specific electronic mail processing portion, and said database is accessible from said receiver terminal for browsing and releasing setting for mail rejection.

17. An electronic mail rejecting method as set forth in claim 10, wherein in said specific mail retuening step, header information of the received electronic mail is added to a header of a return mail, or copies and pastes the header information of the received electronic mail to an electronic mail body, for returning to said specific electronic mail processing portion.

18. An electronic mail rejecting method as set forth in claim 10, wherein in said specific electronic mail processing step, the sender of said specific electronic mail is identified on the basis of a message ID of the sender transmitted by said specific electronic mail returning step and a log obtained from said electronic mail relaying portion.

19. A storage medium storing a control program for implementing an electronic mail rejecting method for rejecting an electronic mail transmitted and received between terminals via a communication network, and disposed an electronic mail relaying portion between a sender terminal and a receiver terminal for relaying an electronic mail from said sender terminal to said receiver terminal, said control program comprising the steps of:
specific electronic mail returning step of returning from the receiver terminal for notifying that the received electronic mail is a specific electronic mail to a specific mail processing portion when the received electronic mail is the specific electronic mail; and
specific mail processing step of identifying the sender of said specific electronic mail on the basis of a content of a return mail returned from said receiver terminal and information obtained from said electronic mail relaying portion.

20. A storage medium as set forth in claim 19, wherein said specific electronic mail processing step of said control program includes a step of transmitting a caution mail to the identified sender.

21. A storage medium as set forth in claim 19, wherein said specific mail processing step of said control program includes a step of performing setting of rejection of electronic mail from said identified sender.

22. A storage medium as set forth in claim 19, wherein said electronic mail relaying portion includes a step of inquiring said specific mail processing portion whether the electronic mail obtained from said sender terminal corresponds to said specific electronic mail or not.

23. A storage medium as set forth in claim 22, wherein said specific mail processing step of said control program includes step of making judgment whether said electronic mail corresponds to said specific electronic mail or not, in response to said inquiry from said electronic mail relaying portion.

24. A storage medium as set forth in claim 23, wherein instruction for stopping transmission of said electronic mail is issued to said electronic mail relaying portion in said specific mail processing step when said electronic mail corresponds to said specific electronic mail.

25. A storage medium as set forth in claim 19, wherein a database of the senders of the specific electronic mails is established in said specific electronic mail processing portion, and said database is accessible from said receiver terminal for browsing and releasing setting for mail rejection.

26. A storage medium as set forth in claim 19, wherein in said specific mail returning step, header information of the received electronic mail is added to a header of a return mail, or copies and pastes the header information of the received electronic mail to an electronic mail body, for returning to said specific electronic mail processing portion.

27. A storage medium as set forth in claim 19, wherein in said specific electronic mail processing step, the sender of said specific electronic mail is identified on the basis of a message ID of the sender transmitted by said specific electronic mail returning step and a log obtained from said electronic mail relaying portion.
